(19) United States
(12) Patent Application Publication
(10) Pub. No.: US 2014/0116749 A1
(43) Pub. Date: May 1, 2014

(54) USE OF POLYCAPROLACTONE PLASTICIZERS IN POLY(VINYL CHLORIDE) COMPOUNDS

(71) Applicant: POLYONE CORPORATION, Avon Lake, OH (US)

(72) Inventors: Craig L SHOEMAKER, North Ridgeville, OH (US); Sang LEE, Westlake, OH (US); John L GRANT, Amherst, OH (US); Joe BERTINO, Avon, OH (US); Alan BARCON, Streetsboro, OH (US)

(73) Assignee: POLYONE CORPORATION, Avon Lake, OH (US)

(21) Appl. No.: 13/797,214

(22) Filed: Mar. 12, 2013

Related U.S. Application Data
(60) Provisional application No. 61/720,836, filed on Oct. 31, 2012.

(51) Int. Cl. C08L 67/00; H01B 3/30; G02B 6/44; C08L 27/06

(52) U.S. Cl. CPC C08L 67/00; C08L 27/06; H01B 3/30; G02B 6/4401
USPC 174/110 SR; 525/190; 524/288; 524/120; 385/100

(57) ABSTRACT

Use of polycaprolactone plasticizer is disclosed for flexible polyvinyl chloride compounds. The compounds can pass the very demanding UL-910 plenum burn test for usage in wire and cable articles.

### CLAIM OF PRIORITY

This application claims priority from U.S. Provisional Patent Application Ser. No. 61/720,836 bearing Attorney Docket Number 12012023 and filed on Oct. 31, 2012, which is incorporated by reference.

### FIELD OF THE INVENTION

This invention concerns use of polycaprolactone to plasticize poly(vinyl chloride) compounds as a replacement for polyvinylidene fluoride in wire and cable coverings, such as insulation and jacketing.

### BACKGROUND OF THE INVENTION

People benefit from plastic articles. From their invention in the mid-20th Century until the present, thermoplastic polymers have become the composition of many consumer products. Such products are relatively lightweight, sturdy, and corrosion resistant.

Plasticized poly(vinyl chloride), invented by Waldo Semon of B.F. Goodrich, has been a top performing plastic resin for decades. Billions of kilograms of poly(vinyl chloride) (also known as “PVC”) resin are molded and extruded each year into countless products. With conventional additives, poly(vinyl chloride) provides unparalleled durability, flame resistance, chemical resistance, weatherability, electrical properties and clarity to name a few.

Wire and cable manufacturers often use plasticized PVC for insulation and sheathing. Performance of plasticized PVC compound at various temperatures is predicted based on accelerated oven aging tests. A cable rated at 60° C. by Underwriters' Laboratories (UL) is tested at 100° C. for seven days, whereas a cable rated at 75° C. is tested at 100° C. for ten days. Some plasticizers conventionally used are phthalates, citrates, soyates, and trimellitates.

Some wire and cable requirements include low smoke generation, measured using both peak optical density and average optical density. PVC plasticized with low smoke plasticizers like phosphates, are particularly suitable in that circumstance. But these formulations are inadequate because they do not pass the UL-910 burn test in certain plenum cable constructions.

When a compound of PVC plasticized with low smoke plasticizers is unable to pass the UL-910 burn test, wire and cable manufacturers use polyvinylidene fluoride (PVDF) for coverings such as insulation and jacketing, particularly jacketing, when the wire or cable is to be used in a plenum construction application which requires low smoke generation.

PVDF is expensive, has difficulty in compatibility with other thermoplastic resins, and sometimes is scarce as a raw material in the market.

### SUMMARY OF THE INVENTION

What is needed in the art is a plasticized PVC to replace PVDF in wire and cable formulations for “coverings”, a term of art which includes both insulation and jacketing materials, particularly for uses in building construction such as riser and plenum locations, and more particularly for wire and cable jacketing requiring low smoke generation.

The present invention solves that problem by using polycaprolactone as that plasticizer, such that polycaprolactone-plasticized PVC can replace PVDF as a covering for low smoke generation flame retardant materials.

One aspect of the present invention is a wire or cable covering, comprising: a mixture of (a) poly(vinyl chloride) and (b) polycaprolactone plasticizing the poly(vinyl chloride), wherein the mixture has a Limiting Oxygen Index of greater 60% according to ASTM D2863; an Elongation at Break of greater than 150% according to ASTM D638 (Type IV); a Plastic Brittleness less than 0° C. according to ASTM D746 as measured in 2° C. increments; and a Dynamic Thermal Stability of more than 25 min according to ASTM 2538.

Another aspect of the present invention is a wire or cable covering described above, wherein the wire or cable is a plenum wire or cable.

Another aspect of the present invention is a wire or cable insulation or jacketing described above, wherein the wire or cable is a riser wire or cable.

Another aspect of the present invention is a wire or cable, comprising a transmission core of optical fiber or metal wire and an insulation or jacketing described above.

Another aspect of the present invention is a method of using plasticized poly(vinyl chloride) in wire or cable covering, comprising the steps: (a) mixing polycaprolactone with polyvinyl chloride to form a plasticized polyvinyl chloride; and (b) extruding the plasticized polyvinyl chloride around a transmission core of optical fiber or metal wire to form a plenum wire or cable which passes the UL-910 test.

Another aspect of the present invention is a plenum wire or cable, comprising: polyvinyl chloride plasticized with polycaprolactone as a covering wherein the plenum wire or cable passes the UL 910 plenum test.

Another aspect of the invention is an industrial curtain comprising the mixture of poly(vinyl chloride) and polycaprolactone described above.

Additional advantages of the invention are explained in reference to embodiments of the invention.

### EMBODIMENTS OF THE INVENTION

Polyvinyl Chloride Resins

Polyvinyl chloride polymers are widely available throughout the world. Polyvinyl chloride resin as referred to in this specification includes polyvinyl chloride homopolymers, vinyl chloride copolymers, graft copolymers, and vinyl chloride polymers polymerized in the presence of any other polymer such as a HDT distortion temperature enhancing polymer, impact toughener, barrier polymer, chain transfer agent, stabilizer, plasticizer or flow modifier.

For example a combination of modifications may be made with the PVC polymer by overpolymerizing a low viscosity, high glass transition temperature (Tg) enhancing agent such as SAN resin, or an imidized polymethacrylate in the presence of a chain transfer agent.

In another alternative, vinyl chloride may be polymerized in the presence of said Tg enhancing agent, the agent having been formed prior to or during the vinyl chloride polymerization. However, only those resins possessing the specified average particle size and degree of friability exhibit the advantages applicable to the practice of the present invention.

In the practice of the invention, there may be used polyvinyl chloride homopolymers or copolymers of polyvinyl chloride comprising one or more comonomers copolymerizable therewith. Suitable comonomers for vinyl chloride include acrylic and methacrylic acids; esters of acrylic and methacrylic acid, wherein the ester portion has from 1 to 12 carbon atoms, for example methyl, ethyl, butyl and ethylhexyl acrylates and the like; methyl, ethyl and butyl methacrylates and the like; hydroxyalkyl esters of acrylic and methacrylic acid, for example hydroxymethyl acrylate, hydroxyethyl acrylate, hydroxyethyl methacrylate and the like; glycidyl esters of acrylic and methacrylic acid, for example glycidyl acrylate, glycidyl methacrylate and the like; alpha, beta unsaturated dicarboxylic acids and their anhydrides, for example maleic acid, fumaric acid, itaconic acid and acid anhydrides of these, and the like; acrylamide and methacrylamide; acrylonitrile and methacrylonitrile; maleimides, for example, N-cyclohexyl maleimide; olefin, for example ethylene, propylene, isobutylene, hexene, and the like; vinylidene chloride, for example, vinylidene chloride; vinyl ester, for example vinyl acetate; vinyl ether, for example methyl vinyl ether, allyl glycidyl ether, n-butyl vinyl ether and the like; crosslinking monomers, for example diallyl phthalate, ethylene glycol dimethacrylate, methylene bis-acrylamide, tracrylyl triazine, divinyl ether, allyl silanes and the like; and including mixtures of any of the above comonomers.

The present invention can also use chlorinated polyvinyl chloride (CPVC), wherein PVC containing approximately 57% chlorine is further reacted with chlorine radicals produced from chlorine gas dispersed in water and irradiated to generate chlorine radicals dissolved in water to produce CPVC, a polymer with a higher glass transition temperature (Tg) and heat distortion temperature. Commercial CPVC typically contains by weight from about 58% to about 70% and preferably from about 63% to about 68% chlorine. CPVC copolymers can be obtained by chlorinating such PVC copolymers using conventional methods such as that described in U.S. Pat. No. 2,996,489, which is incorporated herein by reference. Commercial sources of CPVC include Lubrizol Corporation.

The preferred composition is a polyvinyl chloride homopolymer.

Commercially available sources of polyvinyl chloride polymers include OxyVinyls LP of Dallas, Tex. and Shintech USA of Freeport, Tex.

PVC Compounds

Flexible PVC resin compounds typically contain a variety of additives selected according to the performance requirements of the article produced therefrom well within the understanding of one skilled in the art without the necessity of undue experimentation.

The PVC compounds used herein contain effective amounts of additives ranging from 0.01 to about 500 weight parts per 100 weight parts PVC (parts per hundred resin-phr).

For example, various primary and/or secondary lubricants such as oxidized polyethylene, paraffin wax, fatty acids, and fatty esters and the like can be utilized.

Thermal and ultra-violet light (UV) stabilizers can be utilized such as various organo tins, for example dibutyl tin, dibutyltin-S—S′-bi-(isooctylmercaptoacetate), dibutyl tin dilaurate, dimethyl tin diisooctylthioglycolate, mixed metal stabilizers like Barium Zinc and Calcium Zinc, and lead stabilizers (tri-basic lead sulfate, di-basic lead phthalate, for example). Secondary stabilizers may be included for example a metal salt of phosphoric acid, polyols, and epoxidized oils. Specific examples of salts include water-soluble, alkali metal phosphate salts, disodium hydrogen phosphate, orthophosphates such as mono-, di-, and tri-orthophosphates of said alkali metals, alkali metal polyphosphates, -tetrapolyphosphates and -metaphosphates and the like. Polyols such as sugar alcohols, and epoxides such as epoxidized soybean oil can be used. Typical levels of secondary stabilizers range from about 0.1 wt. parts to about 10.0 wt. parts per 100 wt. parts PVC (phr).

In addition, antioxidants such as phenolics, BPA, BHT, BHA, various hindered phenols and various inhibitors like substituted benzophenones can be utilized.

Various processing aids, fillers, pigments, flame retardants and reinforcing materials can also be utilized in amounts up to about 200 or 300 phr. Exemplary processing aids are acrylic polymers such as poly methyl(meth)acrylate based materials.

Adjustment of melt viscosity can be achieved as well as increasing melt strength by employing 0.5 to 5 phr of commercial acrylic process aids such as those from Rohm and Haas under the Paraloid® trademark. Paraloid®. K-120ND, K-120N, K-175, and other processing aids are disclosed in The Plastics and Rubber Institute: International Conference on PVC Processing, Apr. 26-28, 1983, Paper No. 17.

Examples of fillers include calcium carbonate, clay, silica and various silicates, talc, carbon black and the like. Reinforcing materials include glass fibers, polymer fibers and cellulose fibers. Such fillers are generally added in amounts of from about 3 to about 500 phr of PVC. Preferably from 3 to 300 phr of filler are employed for extruded profiles such as louvers or cove base moldings. Also, flame retardant fillers like ATH (Aluminum trihydrates), AOM (ammonium octamolybdate), antimony trioxides, magnesium oxides and zinc borates are added to boost the flame retardancy of polyvinyl chloride. The concentrations of these fillers range from 1 phr to 200 phr.

Examples of various pigments include titanium dioxide, carbon black and the like. Mixtures of fillers, pigments and/or reinforcing materials also can be used.

The compound of the present invention can include other conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.elsevier.com), can select from many different types of additives for inclusion into the compounds of the present invention.

Non-limiting examples of other optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Polycaprolactone Plasticizer

Polycaprolactone is a polymer of the following structure:

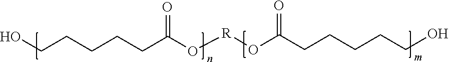

in which R is a diol such as a glycolic moiety; and m and n are integers of sufficient amount to produce a polycaprolactone having a weight average molecular weight of 10,000-80,000 g/mol (ASTM 6579). In other words, commercially available polycaprolactone can have a molecular weight of 10,000 to 80,000 g/mol, a melting point from 58-60° C., and when in solid form, a melt flow index ranging from 3-40 dg/min when measured at 160° C.

Polycaprolactone is known to be an external plasticizer for PVC, according to product literature published by Perstorp, one of the makers of polycaprolactone under its CAPA™ brand name.

What has been found to be unexpected is that the use of polycaprolactone as a plasticizer for PVC is particularly suitable in wire or cable insulation or jacketing, particularly in construction installations such as risers and plenums, and especially for installation in plenum locations in a building.

What made the usage unexpected is the ability of a polycaprolactone-plasticized PVC when constructed as a covering, such as insulation or jacketing, for a cable to achieve a successful test result for UL's UL-910 test for plenum uses which requires at the conclusion of the test: (a) a flame spread horizontally of less than five feet; a value for peak smoke density of less than 0.5 optical density (a dimensionless value); and (c) a value for average smoke density of less than 0.5 optical density. Both peak smoke density and average smoke density are indications of the amount of smoke generation during the test.

The parts by weight of the polycaprolactone plasticizer blend in the PVC compound can range from about 1 to about 120, and preferably from about 25 to about 40 parts per 100 parts of PVC.

Polycaprolactone is commercially available from Perstorp of Toledo, Ohio under the CAPA™ brand. The product range of CAPA™ branded polycaprolactone is currently its 6000 series, with grade 6500 being particularly preferred. As explained below, the compound of the invention can be formed into industrial curtains. For this embodiment, CAPA™ brand grade PL1000 is particularly useful.

Processing

The preparation of compounds of the present invention is as follows. The compound of the present can be made in batch or continuous operations from a powder blend which is typically prepared in a batch-wise operation.

Such powder blending in a batch process typically occurs in a powder mixer such as a Henschel or Littleford mixer, or a ribbon blender that physically mixes all the additives including liquid plasticizers with PVC resin without bringing the polymer matrix to a melting temperature. The mixing speeds range from 60 to 3000 rpm and temperature of mixing can be ambient up to 250° F. (121° C.). In the present invention, all powders are heated to 140° F. (60° C.) and then the polycaprolactone pellets are added, with the mixture then being dropped at 155° F. (68° C.). The output from the mixer is a well blended powder product that can flow into a machine that can bring up the blend temperature to induce melting of some ingredients including the PVC resin.

Mixing in a batch process typically occurs in a Banbury mixer that is also elevated to a temperature that is sufficient to melt the polymer matrix to permit addition of the solid ingredient additives of any optional additive. The mixing speeds range from 60 to 3000 rpm and temperature of mixing ranges from 250° F. to 430° F. (120° C. to 220° C.), typically 325° F. (163° C.). Then, the melted mixture is put on to a two roll mill at 320° F./345° F. (160-174° C.). The material is milled for about four minutes and then the milled, compounded strip is then cubed for later extrusion or molding into polymeric articles.

Compounds can be formed into powder, cubes, or pellets for further extrusion or molding into polymeric components and parts.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.elesevier.com), one can make articles of any conceivable shape and appearance using compounds of the present invention.

### Usefulness of the Invention

Underwriters' Laboratories (UL) perform testing to determine the ratings for wire and cable articles. While articles with a 60° C. or a 75° C. UL rating are useful, there are several types of constructions which require a UL rating of 90° C. or higher ratings. Non-limiting examples of them are low voltage power cables like tray cables, building wires with ratings of THW, THHN and THWN, telecommunications cables, apparatus wires and electric cords.

The UL-910 plenum burn test is very challenging to any wire or cable insulation or jacketing, because in the UL-910 plenum burn test, a 12 inch layer of 24 foot lengths of cable are supported by a one foot wide cable rack, which is filled with the cables. The cables are burned by an 88 kW (300,000 BTU/hr) methane flame. There is also a forced air draft of 240 ft/minute, maintained throughout the 20 minutes of testing. During the burn test, flame spread is observed through small windows spaced one foot apart. Average and peak optical smoke densities are measured by a photocell installed in the exhaust duct. Stated in other words, the UL-910 is the most difficult of currently identified standardized tests for minimization of horizontal flame spread and low smoke generation.

Any elongated material suitable for communicating, transferring or other delivering energy of electrical, optical or other nature is a candidate for the core of the wire or cable of the present invention. Non-limiting examples are metals such as copper or aluminum or silver or combinations of them; ceramics such as glass; and optical grade polymers, such as polycarbonate.

Regardless of the material used as the core to transport energy, the polycaprolactone-plasticized PVC compound then serves as the insulation sleeve or the jacketing cover or both for use in risers or plenums in buildings needing electrical power wires or cables or fiber optic communication wires or cables. Preferably, the compound serves as the jacketing of a plenum wire or cable.

Formation of a wire or cable utilizes conventional techniques known to those having ordinary skill in the art, without undue experimentation. Typically, the core or cores of the wire or cable is/are available along one axis and molten thermoplastic compound is delivered to a specific location using a cross head extrusion die along that axis from an angle ranging from 30 degrees to 150 degrees, with a preference for 90 degrees. Most commonly, the wire is moving along that one axis, in order that delivery of the molten thermoplastic compound to that specific location coats the wire or cable or combination of them or plurality of either or both of them, whereupon cooling forms the insulation or jacket concentrically about the wire or cable. The most common equipment employed is a subset of extrusion equipment called cross head extrusion which propels the core or cores past an extruder dispensing molten thermoplastic compound at approximately 90° to the axis of the moving wire or cable core or cores undergoing cross head extrusion. It has been found that compounds of the present invention can be used as “drop in replacements” for conventional wire and cable covering using conventional draw-down ratios.

As mentioned previously, one embodiment of the invention is a wire or cable specifically configured for use in a riser, the location in a building in which the wire or cable extends vertically from a floor to a wall or the floor to a ceiling or the floor to another floor above or below the original floor. This vertical location requires the wire or cable to satisfy the UL-1666 riser burn test. Briefly, that test requires a test chamber which simulates an eight feet by four feet building wire shaft, with twelve feet of height between the source of ignition and the floor above. A very large propane burner, (about 495,000 BTU/h) is ignited for a period of 30 minutes. Flames must not extend above the 12 foot mark, in order for the cable to pass the test.

Another embodiment of the invention is a wire or cable specifically configured for use in a plenum, the location in a building in which the wire or cable extends horizontally between a ceiling and the floor above. This horizontal location requires the wire or cable to satisfy the UL-910 plenum burn test. The conditions of that test have been described above.

As explained previously, the compound of the invention can be employed as insulation or jacketing of any number of wire or cable structures for transmission of electrical, optical, or other energy. A non-limiting example of a wire or cable of the present invention is a fiber optic cable. Typically, a fiber optic cable comprises multiple fiber optic bundles surrounded by a single layer of polymer compound as a covering. The PVC compound described above can be used as that covering because it can pass the very difficult UL-910 horizontal burn test for plenum uses. As such, PVC compound of the invention can be a less expensive, reliable substitute for PVDF compound for wire and cable covering.

The amount of polymer compound used in a wire or cable covering is identified by UL according to UL 444 which correlates the thickness of the covering in relation to the diameter of the cable core.

Table 1 shows the currently published correlation, with the understanding that if the cable is not round, the equivalent diameter should be calculated using 1.1284*(Thickness of the Cable×Width of the Cable)^{1/2}.

TABLE 1

| | Tensile Strength <17.24 | | Tensile Strength at Least | |
|---|---|---|---|---|
| | MPa (mm) | | 17.24 MPa (mm) | |
| Cable Core | | Min. Ave. | | Min. Ave. |
| Diameter | Min. Ave. | Thickness at | Min. Ave. | Thickness at |
| (mm) | Thickness | Any Point | Thickness | Any Point |
| 0.0-3.3 | 0.33 | 0.25 | 0.33 | 0.25 |
| 3.3-8.89 | 0.58 | 0.46 | 0.33 | 0.25 |
| 8.89-10.16 | 0.69 | 0.56 | 0.46 | 0.36 |
| 10.16-17.78 | 0.81 | 0.66 | 0.46 | 0.36 |
| 17.78-38.10 | 1.14 | 0.91 | 0.76 | 0.61 |
| 38.10-63.50 | 1.52 | 1.22 | 1.14 | 0.91 |
| 63.50-88.90 | 1.91 | 1.52 | 1.52 | 1.22 |

It is also believed that PVC compounds of the present invention can be used in the formation of flexible industrial curtains which also require excellent flame retardancy and low smoke generation. Non-limiting examples of industrial curtain include warehouse entrance curtains, welding curtains, and freezer curtains (including those at retail food stores where frozen food items are on display in open display conditions.)

Further evidence of the invention is found in the following examples.

### EXAMPLES

Table 2 shows the sources of ingredients for all Examples and all Comparative Examples. Table 3 shows the processing conditions for making all experimental samples.

TABLE 2

| Ingredient | Chemical Name | Purpose | Company |
|---|---|---|---|
| SUSP RESIN 240F | PVC Homopolymer | PVC Resin | OxyVinyls |
| | Resin | | |
| SUSP RESIN | PVC Homopolymer | PVC Resin | OxyVinyls |
| OV220F | Resin | | |
| SYNPLAST TOTM | Trioctyltrimellitate | Plasticizer | PolyOne |
| ELECTRICAL | | | |
| SYNPLAST 810TM | 8, 10 Linear | Plasticizer | PolyOne |
| ELECTRICAL | Trimellitate | | |
| SYNPLAST NOTM | Nonyl Octyl Linear | Plasticizer | PolyOne |
| ELECTRICAL | Trimellitate | | |
| DP-45 | Brominated | Plasticizer | Chemtura |
| | Phthalate | | |
| SYNPLAST DOS | Dioctylsebicate | Plasticizer | PolyOne |
| ELECTRICAL | | | |
| SANTICIZER 2148 | Aryl Phosphate | Plasticizer | Ferro |
| DRAPEX 6.8 | Epoxidized | Plasticizer | Chemtura |
| | Soybean Oil | | |
| CAPA PL1000 | Polycaprolactone | Plasticizer | Perstorp |
| CAPA 6500 | Polycaprolactone | Plasticizer | Perstorp |
| CAPA 6250 | Polycaprolactone | Plasticizer | Perstorp |
| CAPA 6400 | Polycaprolactone | Plasticizer | Perstorp |
| CAPA 6430 | Polycaprolactone | Plasticizer | Perstorp |
| CAPA 6800 | Polycaprolactone | Plasticizer | Perstorp |
| NAFTOSAFE 1927 | CaZn Stabilizer | Heat | Chemson |
| SV | | Stabilizer | |
| NAFTOSAFE PKP- | Mixed Metal | Heat | Chemson |
| 717 | Stabilizer | Stabilizer | |
| NAFTOSAFE PKP- | CaZn Stabilizer | Heat | Chemson |
| 1152 | | Stabilizer | |
| MARK 4716 | BaZn Liquid | Heat | Galata |
| | Stabilizer | Stabilizer | Chemicals |
| CHEMSON EH-554 | Mixed Metal | Heat | Chemson |
| | Stabilizer | Stabilizer | |
| MARK 1900 | Tin Stabilizer | Heat | Galata |
| | | Stabilizer | Chemicals |
| REAPAK B-NT | Co-Stabilizer | Co-Heat | Reagens |
| 7444 | booster | Stabilizer | |
| MARK 2225 | Tin Stabilizer | Heat | Chemtura |
| | | Stabilizer | |
| THERMOLITE | Tin Stabilizer | Heat | Arkema |
| 890S | | Stabilizer | |
| THERMOLITE 813 | Tin Stabilizer | Heat | Arkema |
| | | Stabilizer | |
| BURGESS 30 | Calcined Clay | Filler | Burgess |
| ATOMITE | Calcium Carbonate | Filler | Imerys |
| OMYACARB UFT | Calcium Carbonate | Filler | Omya |
| ULTRAPFLEX | Calcium Carbonate | Filler | Specialty |
| | | | Minerals |
| APYRAL 40CD | Aluminum | Flame | Nabaltec |
| | Trihydrate | Retardant | |
| HYMOD 9400 SF | Treated Aluminum | Flame | Huber |
| | Trihydrate | Retardant | Engineered |
| | | | Materials |
| CHARMAX LSZST | Zinc Stannate | Flame | PAG—Polymer |
| | | Retardant | Additives |
| | | | Group |
| KEMGARD MZM | Zinc Molybdate | Smoke | Sherwin |
| | Complex | Suppressant | Williams |
| CAMPINE MT | Antimony Oxide | Flame | Campine |
| | | Retardant | |
| SIDISTAR T120 | Proprietary Blend | Flame | Elkem |
| | | Retardant | |
| EMERSOL 132 | Stearic Acid | Lubricant | Emery |
| | | | Oleo- |
| | | | chemicals |
| PARALOID K-175 | Acrylic Process Aid | Process Aid/ | Dow |
| | | Lubricant | Chemical |
| PE AC-629A | Oxidized | Lubricant | Honeywell |
| | Polyethylene Wax | | |
| CALCIUM | Calcium Stearate | Lubricant | Chemtura |
| STEARATE, FN | | | |
| WESTON EHDP | Phosphite | Phosphite Co | Chemtura |
| | | Stabilizer | |
| WESTON 618F | Phosphite | Phosphite Co | Chemtura |
| | | Stabilizer | |
| ULTRANOX 626 | Phosphite | Phosphite Co | Chemtura |
| | | Stabilizer | |
| LOWINOX CA 22 | Antioxidant | Antioxidant | Chemtura |
| IRGANOX 1076 | Antioxidant | Antioxidant | BASF |
| IRGANOX 1010 | Antioxidant | Antioxidant | BASF |
| KANE ACE PA-20 | Acrylic Resin | Acrylic | Kaneka |
| | | Process Aid | |
| GEON MB2756 | Acrylic Resin | Functional | PolyOne |
| NAT | | Acrylic | |
| DYNEON | PVDF Compound | PVDF | 3M |
| 320080009-PVDF | | Copolymer | |
| | | Compound | |

TABLE 3
Mixing Instructions
#4 Roll Mill/10 L Henschel/Banbury

| | Standard Conditions |
|---|---|
| Resin | Initial |
| STABILIZER (Solids & Liquids) | Directly after Resin |
| Plasticizer | Directly after Resin |
| Processing Aids | Directly after Resin |
| Lubricants | Directly after Resin |
| Fillers | Directly after Resin |
| Pigments | Directly after Resin |
| Titanium Dioxide | Directly after Resin |
| Polycaprolactone Pellets | 140° F. (60° C.) |
| Henschel Drop Temp | <155° F. (<68° C.) |
| Cooler Drop Temp | 140-150° F. (60-65° C.) |

Transfer Powder to Banbury

Set jacket at 300-310° F. (149-154° C.) & speed to 100 rpm
Raise ram twice before dropping fused material ~260° F. & 290° F.
(~127° C. & 143° C.)
Drop Compound at 315-335° F. (157-168° C.) (note sucking sound
when fused) ~325° F. (~163° C.)
Drop Plenum at 340° F. (171° C.) (note sucking sound when fused)

#4 Mill Conditions

Compound

| Initial #4 mill roll set up: | Front | Back |
|---|---|---|
| Mill rolls Temps: | 340° F. | 325° F. |
| | (171° C.) | (163° C.) |
| Roll speed: | 18 rpm | 22 rpm |

Roll gap: 75-90 mils (1.9-2.3 mm)
Mill for 4 minutes.
Set gap ~ 5-10 mils (0.13-0.25 mm) greater than plaque thickness.
Remove mill strip and cut out 6″ × 6″ (15.24 cm × 15.24 cm)
samples for testing.

Table 4 identifies the physical tests performed.

TABLE 4

| | Testing | Test | | |
|---|---|---|---|---|
| Test Name | Authority | No. | Variations | Units |
| Specific Gravity | ASTM | D792 | | — |
| Durometer Hardness, A, | ASTM | D2240 | Shore A | — |
| Instant | | | | |
| Durometer Hardness, A, | ASTM | D2240 | Shore A | — |
| 15 sec delay | | | | |
| Durometer Hardness, D, | ASTM | D2240 | Shore D | — |
| Instant | | | | |
| Durometer Hardness, D, | ASTM | D2240 | Shore D | — |
| 15 sec delay | | | | |
| Flame: LOI Oxygen | ASTM | D2863 | | % |
| Index | | | | Oxygen |
| Flexible Tensile | ASTM | D638 | type IV | psi |
| 100% Modulus | ASTM | D638 | type IV | psi |
| Elongation | ASTM | D638 | type IV | % |
| Cone Calorimeter PHR | ASTM | E1354 | flux 75 kW/m² | kW/m² |
| Cone Calorimeter THR | ASTM | E1354 | flux 75 kW/m² | MJ/m² |
| Cone Calorimeter | ASTM | E1354 | flux 75 kW/m² | m²/kg |
| AvgSEA | | | | |
| Cone Calorimeter | ASTM | E1354 | flux 75 kW/m² | m²/m² |
| TOTSMK | | | | |
| Brittleness of Plastic | ASTM | D746 | 2° C. | ° C. |
| | | | increments | |
| Tear Strength | ASTM | D624 | | ppi |
| Flex Tensile - Oven | ASTM | D638 | type IV | psi |
| Aged 7 Days 100 C. | | | | |
| 100% Modulus | ASTM | D638 | type IV | psi |
| Elongation | ASTM | D638 | type IV | % |
| Retention of Tensile | UL | 444 | | % |
| Retention of Elongation | UL | 444 | | % |
| Flex Tensile - Oven | ASTM | D638 | type IV | psi |
| Aged 7 Days 121 C. | | | | |
| 100% Modulus | ASTM | D638 | type IV | psi |
| Elongation | ASTM | D638 | type IV | % |
| Retention of Tensile | UL | 444 | | % |
| Retention of Elongation | UL | 444 | | % |
| Flex Tensile - Oven | ASTM | D638 | type IV | psi |
| Aged 14 Days 136 C. | | | | |
| 100% Modulus | ASTM | D638 | type IV | psi |
| Elongation | ASTM | D638 | type IV | % |
| Retention of Tensile | UL | 444 | | % |
| Retention of Elongation | UL | 444 | | % |
| Flex Tensile - Oven | ASTM | D638 | type IV | psi |
| Aged 10 Days 100 C. | | | | |
| 100% Modulus | ASTM | D638 | type IV | psi |
| Elongation | ASTM | D638 | type IV | % |
| Retention of Tensile | UL | 444 | | % |
| Retention of Elongation | UL | 444 | | % |
| Dynamic Thermal | ASTM | D2538 | | min. |
| Stability | | | | |
| DTS 205′C 100 rpm first | ASTM | D2538 | | min. |
| color | | | | |
| DTS Torque @ 15 min. | ASTM | D2538 | | mg |
| Temperature @ 15 min. | ASTM | D2538 | | ° C. |
| Torques at 5 minutes | ASTM | D2538 | | mg |
| DTS 10 min torque value | ASTM | D2538 | | mg |
| DTS Torque | ASTM | D2538 | | mg |

Tables 5-14 identify the formulations of the various series of experiments leading unexpectedly to the invention and the physical properties of such experiments using the tests identified in Table 4.

All experiments will be explained prior to the display of Tables 5-14. The objective of the experiments was to identify formulations which satisfied the following four conditions:

Limiting Oxygen Index (LOI) of >60%;

Elongation at Break of >150%;

Brittleness of <0° C., and preferably <−5° C.; and

Dynamic Thermal Stability (DTS) of >25 min, and preferably >30 min.

Series 1

Series 1 explored the possibility of replacing a trimellitate plasticizer with a polycaprolactone plasticizer in a conventional polyvinyl chloride compound used for insulation. The increase in LOI from Experiment 1-A to any of 1-B-1-E showed merit in continued experimentation, even though the LOI was less than 60%.

Series 2

Series 2 also explored the possibility of replacing a trimellitate plasticizer with a polycaprolactone plasticizer, but this time in a conventional low smoke polyvinyl compound used for jacketing. Experiment 2-A was a control. The progression of increasing polycaprolactone content in Experiments 2-B-2-E demonstrated that better formulations used less than about 40 phr of polycaprolactone, even though the DTS condition was not yet met. The extremes of Experiments 2-F, 2-G, and 2-H demonstrated that both brominated phthalate plasticizer and polycaprolactone would be preferred for use in the formulations in order to meet the above-listed conditions. The Experiments 2-1 and 2-J are also controls, with Experiment 2-I being a repeat of Experiment 2-A and Experiment 2-J being the use of 100% PVDF.

Series 3

Experiments 3-A and 3-B were successful in meeting the above-listed conditions, achieved with a combination of 33% plasticizer content of trimellitate and 67% plasticizer content of polycaprolactone. Experiment 3-C showed the addition of calcium carbonate harmed that positive result, while the presence of calcium stearate was acceptable for a successful formulation. Experiments 3-D-3-F used PVDF unsuccessfully, because the formulations were too brittle among other problems.

Series 4

Experiments 4-A-4-H explored the use of various grades of polycaprolactone with the selection of all of Capa™ grades 6250, 6400, 6430, 6500, and 6800 yielding successful formulations.

Series 5

Experiments 5-A-5-H explored the variations in polyvinyl chloride resins, the thermal stabilizer content, and other minor ingredients. Unfortunately, none of these variations improved the performance from Series 4.

Series 6

Experiments 6-A-6-F explored the variations in polyvinyl chloride resins, the amounts of plasticizer, the amounts of thermal stabilizer, the presence of phosphite, and the presence of epoxidized soybean oil. Again, none of these variations improved the performance from Series 4.

Series 7

Series 7 explored variations in polyvinyl chloride resin selection, type of Naftosafe heat stabilizer, amount of Paraloid processing aid, amount of calcium stearate internal lubricant, and the amounts if any of phosphite and tin stabilizer. Unpredictably, the four conditions were met by Experiments 7-A and 7-F, using different polyvinyl chloride resins, different types of Naftosafe heat stabilizer, different amounts of Paraloid processing aid, different amounts of calcium stearate, and different amounts of phosphite. This Series demonstrated the establishment of about a 2:3 ratio of brominated phthalate plasticizer:polycaprolactone was a suitable ratio of plasticizer for providing successful formulations of the invention. Based on this establishment, the ratio of brominated phthalate plasticizer:polycaprolactone can range from about 1:2 to about 1:1 and preferably from about 1:2 to about 3:4.

Series 8

Series 8 explored the addition of conventional bis-phenol stabilizers and anti-oxidants, without success.

Series 9

Series 9 explored the use of the silane treated aluminum trihydrate and also the use of butyl and octyl tin stabilizers, phosphite stabilizers, and co-stabilizer booster in the formulations. Experiments 9-B, 9-C, and 9-D were unsuccessful, because the plastic brittleness was too high. Those Experiments added butyl tin, octyl tin, and octyl tin maleate stabilizers, respectively, something to avoid in formulating of the PVC compounds. Of this Series 9, Experiment 9-G also demonstrated that Weston 618F distearyl pentaerythritol diphosphite was a promising candidate for lowering the Brittleness temperature. With this establishment, the distearyl pentaerythritol diphosphite can be used in an amount ranging from about 0.2 to about 2 and preferably from about 0.5 to about 1.5 parts per hundred of poly(vinyl chloride) resin.

Series 10

Experiment 10-A was a control similar to Experiment 2-A of a conventional low smoke jacketing compound. Experiment 2-A appeared to be a promising candidate, but it failed the UL-910 test after the compound was formed into a covering of ˜0.050 inch thickness for a fiber optic cable having a core diameter of 0.803 inch. Experiment 10-B was a formulation focusing on the use of Weston EHDP phosphite stabilizer and dimethyl tin mercaptan stabilizer. Experiment 10-B was also a promising candidate and also passed the UL-910 test for two of three cables, with the third being a failure because of circumstances related to processing issues. On the basis of this initial result in the UL-910 test, this formulation was the starting point for the variations in Series 11 and Series 12 experiments.

Series 11

Experiments 11A, 11B, and 11C explored the proper balance of stabilizer components. A comparison between Experiment 11-A and 11-B showed that distearyl pentaerythritol diphosphite stabilizer was a valuable ingredient, even at only 1 phr. A comparison of Experiment 11-B and 11-C showed that the presence of dimethyl tin mercaptan diminished performance unacceptably by increasing Brittleness temperature markedly. Experiments 11-D and 11-E repeated the 11-B vs. 11-C comparison using a different polyvinyl chloride resin, demonstrating the robustness of the formulations of Experiments 11-B and 11-D.

Series 12

Experiments 12-A-12-C repeated the formulation of Experiment 11-D. Including Experiment 11-D, the four experiments yielded successful physical property results all four times, demonstrating the robustness of the formulation of Experiments 11-D and 12-A-12-C as a preferred embodiment of the invention.

TABLE 5

| | Experiments | | | | | | | |
|---|---|---|---|---|---|---|---|---|
| | 1-A | 1-B | 1-C | 1-D | 1-E | 2-A | 2-B | 2-C |
| SUSP RESIN 240F | 100.00 | 100.00 | 100.00 | 100.00 | 100.00 | 100.00 | 100.00 | 100.00 |
| SYNPLAST TOTM ELECTRICAL | 52.00 | | | | | | | |
| SYNPLAST 810TM ELECTRICAL | | | | | | 33.00 | 0.00 | 0.00 |
| DP-45 | | | | | | 22.00 | 22.00 | 16.50 |
| SYNPLAST DOS ELECTRICAL | | | | | | 0.00 | 0.00 | 0.00 |
| SANTICIZER 2148 | | | | | | 0.00 | 0.00 | 0.00 |
| CAPA PL1000 | | 52.00 | 45.00 | | | | | |
| CAPA 6500 | | | | 52 | 45 | 0.00 | 33.00 | 38.50 |
| NAFTOSAFE 1927 SV | 5.00 | 5.00 | 5.00 | 5.00 | 5.00 | | | |
| NAFTOSAFE PKP-717 | | | | | | 8.00 | 8.00 | 8.00 |
| BURGESS 30 | 12.00 | 12.00 | 12.00 | 12.00 | 12.00 | | | |
| ATOMITE | 8.00 | 8.00 | 8.00 | 8.00 | 8.00 | | | |
| APYRAL 40CD | | | | | | 43.00 | 43.00 | 43.00 |
| HYMOD 9400 SF | | | | | | 43.00 | 43.00 | 43.00 |
| CHARMAX LSZST | | | | | | 10.00 | 10.00 | 10.00 |
| KEMGARD MZM | | | | | | 7.50 | 7.50 | 7.50 |
| CAMPINE MT | 2.00 | 2.00 | 2.00 | 2.00 | 2.00 | 2.00 | 2.00 | 2.00 |
| Sidistar T120 | | | | | | 0.00 | 0.00 | 0.00 |
| EMERSOL 132 | 0.15 | 0.15 | 0.15 | 0.15 | 0.15 | | | |
| PARALOID K-175 | | | | | | 1.20 | 1.20 | 1.20 |
| PE AC-629A | 0.10 | 0.10 | 0.10 | 0.10 | 0.10 | 0.20 | 0.20 | 0.20 |
| Testing | | | | | | | | |
| Specific Gravity | 1.33 | 1.38 | 1.40 | 1.39 | 1.40 | 1.63 | 1.67 | 1.65 |
| Durometer Hardness, A, Instant | 94 | 94 | 97 | 95 | 97 | 97 | 96 | 97 |
| Durometer Hardness, A, 15 sec delay | 89 | 88 | 93 | 90 | 93 | 96 | 95 | 95 |
| Durometer Hardness, D, Instant | 53 | 51 | 60 | 56 | 63 | 65 | 70 | 69 |
| Durometer Hardness, D, 15 sec delay | 37 | 36 | 45 | 40 | 47 | 55 | 55 | 54 |
| Flame: LOI Oxygen Index | 27.7 | 30.4 | 31.4 | 31.7 | 33.6 | 55.6 | 62.6 | 61.4 |
| Flexible Tensile | 2700 | 2960 | 3150 | 2570 | 2640 | 2160 | 2210 | 2210 |
| 100% Modulus | 1880 | 1930 | 2280 | 1980 | 2200 | 1820 | 1830 | 1780 |
| Elongation | 309 | 315 | 304 | 282 | 304 | 221 | 265 | 265 |
| Cone Calorimeter PHR | | | | | | 134 | 74 | 82 |
| Cone Calorimeter THR | | | | | | 61 | 59 | 64 |
| Cone Calorimeter AvgSEA | | | | | | 296 | 88 | 104 |
| Cone Calorimeter TOTSMK | | | | | | 2049 | 680 | 810 |
| Brittleness of Plastic | −20 | −19 | −13 | −25 | −24 | −7 | −8.4 | −10.4 |
| Dynamic Thermal Stability | | | | | | 62 | 17 | 15 |
| Flex Tensile - Oven Aged 7 Days 100 C. | | | | | | 2140 | 2170 | 2120 |
| 100% Modulus | | | | | | 1860 | 1860 | 1820 |
| Elongation | | | | | | 212 | 253 | 249 |
| Retention of Tensile | | | | | | 99% | 98% | 96% |
| Retention of Elongation | | | | | | 96% | 95% | 94% |
| Flex Tensile - Oven Aged 7 Days 121 C. | 3030 | 3130 | 3110 | 2830 | 2910 | | | |
| 100% Modulus | 2060 | 2170 | 2560 | 2120 | 2270 | | | |
| Elongation | 335 | 305 | 256 | 341 | 361 | | | |
| Retention of Tensile | 112% | 106% | 99% | 110% | 110% | | | |
| Retention of Elongation | 108% | 97% | 84% | 121% | 119% | | | |
| Flex Tensile - Oven Aged 14 Days 136 C. | 2920 | 3010 | 3100 | 2820 | 2940 | | | |
| 100% Modulus | 2800 | 2870 | 2990 | 2290 | 2650 | | | |
| Elongation | 235 | 224 | 142 | 315 | 251 | | | |
| Retention of Tensile | 108% | 102% | 98% | 110% | 111% | | | |
| Retention of Elongation | 76% | 71% | 47% | 112% | 83% | | | |
| DTS 10 min torque value | | | | | | 530 | 1120 | 1130 |
| 10 MHz - DC | 2.91 | 4.11 | 3.92 | 3.77 | 3.74 | | | |
| 10 MHz - DF | 0.0396 | 0.0626 | 0.0527 | 0.0476 | 0.0419 | | | |

TABLE 6

| | Experiments | | | | | | | |
|---|---|---|---|---|---|---|---|---|
| | 2-D | 2-E | 2-F | 2-G | 2-H | 2-I | 2-J | 3-A |
| SUSP RESIN 240F | 100.00 | 100.00 | 100.00 | 100.00 | 100.00 | 100.00 | | 100.00 |
| SYNPLAST 810TM ELECTRICAL | 0.00 | 0.00 | 33.00 | 0.00 | 33.00 | 33.00 | | 11.00 |
| DP-45 | 11.00 | 5.50 | 11.00 | 0.00 | 0.00 | 22.00 | | 22.00 |
| SYNPLAST DOS ELECTRICAL | 0.00 | 0.00 | 0.00 | 11.00 | 0.00 | | | |
| SANTICIZER 2148 | 0.00 | 0.00 | 11.00 | 11.00 | 22.00 | | | |
| CAPA 6500 | 44.00 | 49.50 | 0.00 | 33.00 | 0.00 | | | 22.00 |
| NAFTOSAFE PKP-717 | 8.00 | 8.00 | 8.00 | 8.00 | 8.00 | 8.00 | | 8.00 |
| APYRAL 40CD | 43.00 | 43.00 | 18.00 | 56.00 | 56.00 | 43.00 | | 40.00 |
| HYMOD 9400 SF | 43.00 | 43.00 | 55.00 | 30.00 | 30.00 | 43.00 | | 40.00 |
| CHARMAX LSZST | 10.00 | 10.00 | 7.50 | 7.50 | 7.50 | 10.00 | | 15.00 |
| KEMGARD MZM | 7.50 | 7.50 | 10.00 | 10.00 | 10.00 | 7.50 | | 7.50 |
| CAMPINE MT | 2.00 | 2.00 | 2.00 | 2.00 | 2.00 | 2.00 | | 2.00 |
| PARALOID K-175 | 1.20 | 1.20 | 1.20 | 1.20 | 1.20 | 1.20 | | 1.20 |
| PE AC-629A | 0.20 | 0.20 | 0.20 | 0.20 | 0.20 | 0.20 | | 0.20 |
| DYNEON 32008 0009-PVDF | | | | | | | 100.00 | 0.00 |
| Testing | | | | | | | | |
| Specific Gravity | 1.64 | 1.63 | 1.59 | 1.59 | 1.57 | 1.63 | 1.82 | 1.66 |
| Durometer Hardness, A, Instant | 96 | 96 | 97 | 94 | 96 | | | |
| Durometer Hardness, A, 15 sec delay | 94 | 94 | 94 | 89 | 92 | | | |
| Durometer Hardness, D, Instant | 67 | 65 | 62 | 53 | 56 | 68 | 58 | 69 |
| Durometer Hardness, D, 15 sec delay | 52 | 50 | 49 | 40 | 43 | 56 | 46 | 55.1 |
| Flame: LOI Oxygen Index | 59.1 | 58.8 | 44.2 | 43.9 | 39.1 | 55.0 | >80 | 62.3 |
| Flexible Tensile | 2110 | 2110 | 1400 | 1990 | 2000 | 1980 | 1210 | 2190 |
| 100% Modulus | 1760 | 1640 | — | 1280 | 1360 | 2000 | 1200 | 1960 |
| Elongation | 244 | 287 | 82 | 311 | 275 | 204 | 204 | 247 |
| Cone Calorimeter PHR | 82 | 86 | 128 | 101 | 140 | 131 | 49 | 83.4 |
| Cone Calorimeter THR | 66 | 73 | 72 | 95 | 80 | 63 | 38 | 53.6 |
| Cone Calorimeter AvgSEA | 131 | 183 | 409 | 264 | 377 | 292 | 5 | 5745 |
| Cone Calorimeter TOTSMK | 960 | 1282 | 2613 | 1967 | 2496 | 2006 | 60 | 1145 |
| Brittleness of Plastic | −13.6 | −17 | −7.4 | −30.2 | −20.8 | −7 | −37 | −10.2 |
| Dynamic Thermal Stability | 12 | 11 | 90 | 26 | 69 | >90 | >90 | 40 |
| Flex Tensile - Oven Aged 7 Days 100 C. | 2170 | 2180 | 1520 | 2040 | 2010 | | | 2240 |
| 100% Modulus | 1810 | 1750 | — | 1660 | 1510 | | | 1990 |
| Elongation | 263 | 273 | 58 | 274 | 249 | | | 245 |
| Retention of Tensile | 103% | 103% | 109% | 103% | 101% | | | 102% |
| Retention of Elongation | 108% | 95% | 71% | 88% | 91% | | | 99% |
| Flex Tensile - Oven Aged 7 Days 121 C. | | | | | | 1980 | 1230 | 2260 |
| 100% Modulus | | | | | | — | 1240 | 2200 |
| Elongation | | | | | | 91 | 145 | 173 |
| Retention of Tensile | | | | | | 100% | 102% | 103% |
| Retention of Elongation | | | | | | 45% | 1% | 70% |
| Flex Tensile - Oven Aged 10 Days 100 C. | | | | | | | | 2200 |
| 100% Modulus | | | | | | | | 1950 |
| Elongation | | | | | | | | 248 |
| Retention of Tensile | | | | | | | | 100% |
| Retention of Elongation | | | | | | | | 100% |
| DTS 205′ C. 100 rpm first color | | | | | | | | 23 |
| DTS Torque @ 15 min. | | | | | | 526 | 1132 | 1014 |
| DTS 10 min torque value | 1160 | 1200 | 300 | 810 | 410 | | | |

TABLE 7

| | Experiments | | | | | | | |
|---|---|---|---|---|---|---|---|---|
| | 3-B | 3-C | 3-D | 3-E | 3-F | 4-A | 4-B | 4-C |
| SUSP RESIN 240F | 100.00 | 100.00 | 100.00 | 100.00 | 100.00 | 100.00 | 100.00 | 100.00 |
| SYNPLAST 810TM ELECTRICAL | 11.00 | 11.00 | 11.00 | 11.00 | 11.00 | 33.00 | 0.00 | 0.00 |
| DP-45 | 22.00 | 22.00 | 22.00 | 22.00 | 22.00 | 22.00 | 22.00 | 22.00 |
| CAPA 6500 | 22.00 | 22.00 | 22.00 | 22.00 | 22.00 | 0.00 | 0.00 | 0.00 |
| CAPA 6250 | | | | | | 0.00 | 33.00 | 0.00 |
| CAPA 6400 | | | | | | 0.00 | 0.00 | 33.00 |
| NAFTOSAFE 1927 SV | 5.00 | 5.00 | 5.00 | 5.00 | 5.00 | | | |
| NAFTOSAFE PKP-717 | 5.00 | 5.00 | 5.00 | 5.00 | 5.00 | 4.50 | 4.50 | 4.50 |
| NAFTOSAFE PKP-1152 | | | | | | 4.50 | 4.50 | 4.50 |
| OMYACARB UFT | 0.00 | 5.00 | 5.00 | 5.00 | 5.00 | | | |
| APYRAL 40CD | 39.00 | 37.00 | 37.00 | 37.00 | 37.00 | 43.00 | 43.00 | 43.00 |
| HYMOD 9400 SF | 39.00 | 36.00 | 36.00 | 36.00 | 36.00 | 43.00 | 43.00 | 43.00 |
| CHARMAX LSZST | 15.00 | 15.00 | 15.00 | 15.00 | 15.00 | 10.00 | 10.00 | 10.00 |
| KEMGARD MZM | 7.50 | 7.50 | 7.50 | 7.50 | 7.50 | 7.50 | 7.50 | 7.50 |
| CAMPINE MT | 2.00 | 2.00 | 2.00 | 2.00 | 2.00 | 2.00 | 2.00 | 2.00 |
| PARALOID K-175 | 1.20 | 1.20 | 1.20 | 1.20 | 1.20 | 1.20 | 1.20 | 1.20 |
| PE AC-629A | 0.20 | 0.20 | 0.20 | 0.20 | 0.20 | 0.20 | 0.20 | 0.20 |
| CALCIUM STEARATE, FN | 0.40 | 0.40 | 0.40 | 0.40 | 0.40 | | | |
| KANE ACE PA-20 | 0.00 | 0.00 | 0.00 | 24.50 | 0.00 | | | |
| GEON MB2756 NAT | 0.00 | 0.00 | 0.00 | 0.00 | 24.50 | | | |
| DYNEON 32008 0009-PVDF | 0.00 | 0.00 | 115.40 | 114.20 | 114.20 | | | |
| Testing | | | | | | | | |
| Specific Gravity | 1.66 | 1.66 | 1.70 | 1.65 | 1.6565 | 1.63 | 1.67 | 1.67 |
| Durometer Hardness, D, Instant | 67.8 | 68.3 | 66.1 | 67.6 | 62.5 | 66.1 | 69.6 | 66.7 |
| Durometer Hardness, D, 15 sec delay | 54 | 53.6 | 49.1 | 52.5 | 45.3 | 54.7 | 55.2 | 55.1 |
| Flame: LOI Oxygen Index | 60.6 | 57.1 | 55.9 | 53.1 | 52.7 | 53 | 62.6 | 62.2 |
| Flexible Tensile | 2230 | 2070 | 1340 | 1870 | 1330 | 1990 | 2110 | 2080 |
| 100% Modulus | 1790 | 1810 | — | 1840 | 1300 | 1730 | 1840 | 1780 |
| Elongation | 275 | 219 | 61.6 | 140 | 106 | 186 | 209 | 225 |
| Cone Calorimeter PHR | 95.9 | 94.6 | | | | | | |
| Cone Calorimeter THR | 55.3 | 52.7 | | | | | | |
| Cone Calorimeter AvgSEA | 6032 | 6623 | | | | | | |
| Cone Calorimeter TOTSMK | 1366 | 1417 | | | | | | |
| Brittleness of Plastic | −11 | −10.4 | 9.6 | 11.2 | 10.6 | −7.8 | −5 | −6 |
| Dynamic Thermal Stability | 68 | 55 | >90 | 70 | 70 | 159 | 60 | 59 |
| Tear Strength | | | | | | 396 | 472 | 498 |
| Flex Tensile - Oven Aged 7 Days 121 C. | 2130 | 2170 | 1120 | 2050 | 1340 | 2010 | 2010 | 2060 |
| 100% Modulus | 1850 | 1880 | — | 1970 | — | 1830 | 1830 | 1840 |
| Elongation | 231 | 235 | 88 | 158 | 68 | 160 | 208 | 223 |
| Retention of Tensile | 96% | 105% | 84% | 110% | 101% | 101% | 95% | 99% |
| Retention of Elongation | 84% | 107% | 143% | 113% | 64% | 86% | 100% | 99% |
| Flex Tensile - Oven Aged 7 Days 100 C. | 2210 | 2180 | 1080 | 1970 | 1290 | 1800 | 2100 | 2170 |
| 100% Modulus | 1830 | 1790 | — | 1920 | — | 1610 | 1790 | 1810 |
| Elongation | 254 | 255 | 96 | 146 | 102 | 165 | 228 | 217 |
| Retention of Tensile | 99% | 105% | 81% | 105% | 97% | 90% | 100% | 104% |
| Retention of Elongation | 92% | 116% | 156% | 104% | 96% | 89% | 109% | 96% |
| Flex Tensile - Oven Aged 10 Days 100 C. | 2070 | 2120 | 1120 | 1830 | 1260 | 1800 | 2000 | 2130 |
| 100% Modulus | 1710 | 1770 | 1080 | 1780 | 1030 | 1640 | 1760 | 1790 |
| Elongation | 252 | 258 | 127 | 141 | 114 | 158 | 210 | 242 |
| Retention of Tensile | 93% | 102% | 84% | 98% | 95% | 90% | 95% | 102% |
| Retention of Elongation | 92% | 118% | 206% | 101% | 108% | 85% | 100% | 108% |
| DTS 205′ C. 100 rpm first color | 43 | 43 | 53 | 43 | 43 | 63 | 43 | 43 |
| DTS Torque @ 15 min. | 860 | 867 | 812 | 1040 | 750 | 490 | 966 | 1009 |

TABLE 8

| | Experiments | | | | | | | |
|---|---|---|---|---|---|---|---|---|
| | 4-D | 4-E | 4-F | 4-G | 4-H | 5-A | 5-B | 5-C |
| SUSP RESIN 240F | 100.00 | 100.00 | 100.00 | 100.00 | 100.00 | 100.00 | 0.00 | 100.00 |
| SYNPLAST 810TM ELECTRICAL | 0.00 | 0.00 | 0.00 | 11.00 | 22.00 | | | |
| DP-45 | 22.00 | 22.00 | 22.00 | 22.00 | 22.00 | 22.00 | 22.00 | 22.00 |
| CAPA 6500 | 0.00 | 33.00 | 0.00 | 0.00 | 0.00 | 33.00 | 33.00 | 33.00 |
| CAPA 6250 | 0.00 | 0.00 | 0.00 | 22.00 | 11.00 | | | |
| CAPA 6430 | 33.00 | 0.00 | 0.00 | 0.00 | 0.00 | | | |
| CAPA 6800 | 0.00 | 0.00 | 33.00 | 0.00 | 0.00 | | | |
| NAFTOSAFE PKP-717 | 4.50 | 4.50 | 4.50 | 4.50 | 4.50 | 4.50 | 4.50 | 0.00 |
| NAFTOSAFE PKP-1152 | 4.50 | 4.50 | 4.50 | 4.50 | 4.50 | 4.50 | 4.50 | 8.00 |
| ULTRAPFLEX | | | | | | 0.00 | 0.00 | 2.00 |
| APYRAL 40CD | 43.00 | 43.00 | 43.00 | 43.00 | 43.00 | 43.00 | 43.00 | 42.00 |
| HYMOD 9400 SF | 43.00 | 43.00 | 43.00 | 43.00 | 43.00 | 43.00 | 43.00 | 42.00 |
| CHARMAX LSZST | 10.00 | 10.00 | 10.00 | 10.00 | 10.00 | 10.00 | 10.00 | 10.00 |
| KEMGARD MZM | 7.50 | 7.50 | 7.50 | 7.50 | 7.50 | 7.50 | 7.50 | 7.50 |
| CAMPINE MT | 2.00 | 2.00 | 2.00 | 2.00 | 2.00 | 2.00 | 2.00 | 2.00 |
| PARALOID K-175 | 1.20 | 1.20 | 1.20 | 1.20 | 1.20 | 1.20 | 1.20 | 1.20 |
| PE AC-629A | 0.20 | 0.20 | 0.20 | 0.20 | 0.20 | 0.20 | 0.20 | 0.20 |
| CALCIUM STEARATE, FN | | | | | | 0.00 | 0.50 | 0.50 |
| Testing | | | | | | | | |
| Specific Gravity | 1.67 | 1.67 | 1.67 | 1.66 | 1.64 | 1.66 | 1.65 | 1.66 |
| Durometer Hardness, D, Instant | 68.7 | 69.2 | 68.2 | 65.4 | 64.4 | 71.1 | 67 | 66.4 |
| Durometer Hardness, D, 15 sec delay | 55 | 56.4 | 55.9 | 52.9 | 55 | 57.2 | 55 | 55.7 |
| Flame: LOI Oxygen Index | 61.4 | 61.9 | 62.4 | 59.3 | 53 | | | |
| Flexible Tensile | 2100 | 2150 | 2270 | 2030 | 2150 | 2312 | 2001 | 2274 |
| 100% Modulus | 1710 | 1730 | 1710 | 1690 | 1830 | 1878 | 1618 | 1829 |
| Elongation | 262 | 268 | 309 | 239 | 222 | 264 | 284 | 270 |
| Brittleness of Plastic | −7.6 | −10 | −12.8 | −6 | −6.4 | | | |
| Dynamic Thermal Stability | 49 | 46 | 29 | 101 | 152 | 26 | 39 | 34 |
| Tear Strength | 499 | 511 | 536 | 455 | 461 | | | |
| Flex Tensile - Oven Aged 7 Days 121 C. | 2110 | 2210 | 2240 | 2670 | 2080 | | | |
| 100% Modulus | 1900 | 1910 | 1830 | 2240 | 1920 | | | |
| Elongation | 196 | 241 | 296 | 224 | 177 | | | |
| Retention of Tensile | 100% | 103% | 99% | 132% | 97% | | | |
| Retention of Elongation | 75% | 90% | 96% | 94% | 80% | | | |
| Flex Tensile - Oven Aged 7 Days 100 C. | 2200 | 2250 | 2380 | 2120 | 2270 | | | |
| 100% Modulus | 1980 | 1950 | 1930 | 1850 | 1930 | | | |
| Elongation | 213 | 246 | 299 | 215 | 217 | | | |
| Retention of Tensile | 105% | 105% | 105% | 104% | 106% | | | |
| Retention of Elongation | 81% | 92% | 97% | 90% | 98% | | | |
| Flex Tensile - Oven Aged 10 Days 100 C. | 2000 | 1880 | 2110 | 2050 | 2190 | | | |
| 100% Modulus | 1540 | 1810 | 1730 | 1780 | 1870 | | | |
| Elongation | 207 | 208 | 270 | 220 | 229 | | | |
| Retention of Tensile | 95% | 87% | 93% | 101% | 102% | | | |
| Retention of Elongation | 79% | 78% | 87% | 92% | 103% | | | |
| DTS 205′ C. 100 rpm first color | 33 | 23 | 20 | 43 | 53 | | | |
| DTS Torque @ 15 min. | 1152 | 1254 | 1424 | 750 | 604 | 514 | 407 | 463 |

TABLE 9

| | Experiments | | | | | | | |
|---|---|---|---|---|---|---|---|---|
| | 5-D | 5-E | 5-F | 5-G | 5-H | 6-A | 6-B | 6-C |
| SUSP RESIN 240F | 0.00 | 100.00 | 100.00 | 0.00 | 100.00 | 0.00 | 0.00 | 0.00 |
| SUSP RESIN OV220F | 100.00 | 0.00 | 0.00 | 100.00 | 0.00 | 100.00 | 100.00 | 100.00 |
| DP-45 | 22.00 | 20.00 | 22.00 | 22.00 | 22.00 | 22.00 | 21.00 | 21.00 |
| DRAPEX 6.8 | 0.00 | 5.00 | 0.00 | 0.00 | 0.00 | 0.00 | 3.00 | 3.00 |
| CAPA 6500 | 33.00 | 30.00 | 33.00 | 33.00 | 33.00 | 33.00 | 31.00 | 31.00 |
| NAFTOSAFE PKP-717 | 0.00 | 2.00 | 2.00 | 0.00 | 0.00 | 0.00 | 0.00 | 3.00 |
| NAFTOSAFE PKP-1152 | 8.00 | 2.00 | 2.00 | 0.00 | 0.00 | 8.00 | 8.00 | 5.00 |
| MARK 4716 | 0.00 | 4.00 | 0.00 | 0.00 | 0.00 | | | |
| MARK 1900 | 0.00 | 0.00 | 2.50 | 4.00 | 2.50 | 0.00 | 0.00 | 0.00 |
| REAPAK B-NT 7444 | 0.00 | 0.00 | 0.00 | 0.00 | 0.50 | | | |
| ULTRAPFLEX | 0.00 | 0.00 | 0.00 | 0.00 | 2.00 | | | |
| APYRAL 40CD | 43.00 | 43.00 | 43.00 | 45.00 | 44.00 | 43.00 | 43.00 | 43.00 |
| HYMOD 9400 SF | 43.00 | 43.00 | 43.00 | 45.00 | 44.00 | 43.00 | 43.00 | 43.00 |
| CHARMAX LSZST | 10.00 | 10.00 | 10.00 | 10.00 | 10.00 | 10.00 | 10.00 | 10.00 |
| KEMGARD MZM | 7.50 | 7.50 | 7.50 | 7.50 | 7.50 | 7.50 | 7.50 | 7.50 |
| CAMPINE MT | 2.00 | 2.00 | 2.00 | 2.00 | 2.00 | 2.00 | 2.00 | 2.00 |
| PARALOID K-175 | 1.20 | 1.20 | 1.20 | 1.20 | 1.20 | 1.20 | 1.20 | 1.20 |
| PE AC-629A | 0.20 | 0.20 | 0.20 | 0.20 | 0.20 | 0.20 | 0.20 | 0.20 |
| CALCIUM STEARATE, FN | 0.50 | 0.50 | 0.75 | 0.75 | 0.50 | 0.50 | 0.50 | 0.50 |
| WESTON EHDP | 1.00 | 0.00 | 0.00 | 0.00 | 1.00 | 1.50 | 1.00 | 1.50 |
| Testing | | | | | | | | |
| Specific Gravity | 1.65 | 1.63 | 1.65 | | | 1.64 | 1.64 | 1.64 |
| Durometer Hardness, A, Instant | | | | | | | | |
| Durometer Hardness, A, 15 sec delay | | | | | | | | |
| Durometer Hardness, D, Instant | 63.6 | 64.4 | 66.4 | | | 67.1 | 67.1 | 66.4 |
| Durometer Hardness, D, 15 sec delay | 51.5 | 49.7 | 50.6 | | | 52.5 | 52.1 | 50.7 |
| Flame: LOI Oxygen Index | | | | | | 59.8 | 59.2 | 56.4 |
| Flexible Tensile | 2067 | 2070 | 2033 | | | 2021 | 2098 | 2010 |
| 100% Modulus | 1648 | 1617 | 1684 | | | 1708 | 1729 | 1705 |
| Elongation | 277 | 282 | 237 | | | 257 | 259 | 246 |
| Dynamic Thermal Stability | 48 | 45 | 39 | | | 41 | 47 | 48 |
| DTS Torque @ 15 min. | 367 | 412 | 390 | | | | | |
| DTS Torque | | | | | | 426 | 372 | 367 |

TABLE 10

| | Experiments | | | | | | | |
|---|---|---|---|---|---|---|---|---|
| | 6-D | 6-E | 6-F | 7-A | 7-B | 7-C | 7-D | 7-E |
| SUSP RESIN 240F [DPK] | 0.00 | 0.00 | 100.00 | 100.00 | 100.00 | 100.00 | 100.00 | 100.00 |
| SUSP RESIN OV220F | 100.00 | 100.00 | 0.00 | 0.00 | 0.00 | 0.00 | 0.00 | 0.00 |
| DP-45 | 21.00 | 20.00 | 21.00 | 22.00 | 22.00 | 22.00 | 22.00 | 22.00 |
| DRAPEX 6.8 | 3.00 | 5.00 | 3.00 | | | | | |
| CAPA 6500 | 31.00 | 30.00 | 31.00 | 33.00 | 33.00 | 33.00 | 33.00 | 33.00 |
| NAFTOSAFE PKP-717 | 3.00 | 3.00 | 3.00 | 8.00 | 4.50 | 4.50 | 4.50 | 4.50 |
| NAFTOSAFE PKP-1152 | 5.00 | 5.00 | 5.00 | 0.00 | 4.50 | 4.50 | 4.50 | 4.50 |
| MARK 1900 | 1.50 | 0.00 | 2.00 | 0.00 | 0.00 | 0.50 | 1.00 | 0.75 |
| APYRAL 40CD | 43.00 | 43.00 | 43.00 | 43.00 | 43.00 | 43.00 | 43.00 | 43.00 |
| HYMOD 9400 SF | 43.00 | 43.00 | 43.00 | 43.00 | 43.00 | 43.00 | 43.00 | 43.00 |
| CHARMAX LSZST | 10.00 | 10.00 | 10.00 | 10.00 | 10.00 | 10.00 | 10.00 | 10.00 |
| KEMGARD MZM | 7.50 | 7.50 | 7.50 | 7.50 | 7.50 | 7.50 | 7.50 | 7.50 |
| CAMPINE MT | 2.00 | 2.00 | 2.00 | 2.00 | 2.00 | 2.00 | 2.00 | 2.00 |
| PARALOID K-175 | 1.20 | 1.20 | 1.20 | 1.20 | 0.90 | 0.90 | 0.90 | 0.90 |
| PE AC-629A | 0.25 | 0.20 | 0.25 | 0.20 | 0.15 | 0.15 | 0.15 | 0.15 |
| CALCIUM STEARATE, FN | 0.75 | 0.50 | 0.75 | 0.00 | 0.50 | 0.50 | 0.50 | 0.50 |
| WESTON EHDP | 1.00 | 1.00 | 1.00 | 0.00 | 1.00 | 1.00 | 1.00 | 0.00 |
| Testing | | | | | | | | |
| Specific Gravity | 1.63 | 1.65 | 1.64 | 1.66 | 1.66 | 1.66 | 1.65 | 1.66 |
| Durometer Hardness, D, Instant | 63.7 | 64.8 | 62.2 | 69.8 | 66.8 | 65.2 | 64.8 | 67.9 |
| Durometer Hardness, D, 15 sec delay | 46.7 | 50.2 | 45.7 | 55.9 | 51.6 | 51.2 | 49.7 | 51.9 |
| Flame: LOI Oxygen Index | 53.3 | 58.9 | 54.9 | 61.8 | 59.4 | 61.4 | 58.5 | 59.2 |
| Flexible Tensile | 2030 | 1975 | 2246 | 2298 | 2217 | 2253 | 2241 | 2228 |
| 100% Modulus | 1856 | 1765 | 1959 | 1926 | 1775 | 1832 | 1801 | 1877 |
| Elongation | 190 | 206 | 218 | 304 | 292 | 266 | 257 | 246 |
| Brittleness of Plastic | | | | −5 | −11 | >−2 | >−2 | >−2 |
| Dynamic Thermal Stability | 73 | 48 | 57 | 40 | 43 | 45 | 37 | 34 |
| Flex Tensile - Oven Aged 7 Days 100 C. | | | | 2288 | 2195 | 2168 | 2275 | 2254 |
| 100% Modulus | | | | 1983 | 1814 | 1895 | 1989 | 1934 |
| Elongation | | | | 294 | 280 | 235 | 225 | 242 |
| Retention of Tensile | | | | 100% | 99% | 96% | 102% | 101% |
| Retention of Elongation | | | | 97% | 96% | 88% | 88% | 98% |
| DTS 10 min torque value | | | | 1250 | 1024 | 863 | 800 | 891 |
| DTS Torque | 241 | 357 | 294 | | | | | |

TABLE 11

| | Experiments | | | | | | | |
|---|---|---|---|---|---|---|---|---|
| | 7-F | 7-G | 8-A | 8-B | 8-C | 8-D | 8-E | 8-F |
| SUSP RESIN 240F | 0.00 | 0.00 | 100.00 | 100.00 | 100.00 | 100.00 | 100.00 | 100.00 |
| SUSP RESIN OV220F | 100.00 | 100.00 | | | | | | |
| DP-45 | 22.00 | 22.00 | 22.00 | 22.00 | 22.00 | 22.00 | 22.00 | 22.00 |
| CAPA 6500 | 33.00 | 33.00 | 33.00 | 33.00 | 33.00 | 33.00 | 33.00 | 33.00 |
| NAFTOSAFE PKP-717 | 4.50 | 4.50 | 4.50 | 4.50 | 4.50 | 4.50 | 4.50 | 4.50 |
| NAFTOSAFE PKP-1152 | 4.50 | 4.50 | 4.50 | 4.50 | 4.50 | 4.50 | 4.50 | 4.50 |
| MARK 1900 | 0.75 | 0.00 | 0.00 | 0.00 | 0.00 | 0.00 | 0.00 | 0.15 |
| APYRAL 40CD | 43.00 | 43.00 | 43.00 | 43.00 | 43.00 | 43.00 | 43.00 | 43.00 |
| HYMOD 9400 SF | 43.00 | 43.00 | 43.00 | 43.00 | 43.00 | 43.00 | 43.00 | 43.00 |
| CHARMAX LSZST | 10.00 | 10.00 | 10.00 | 10.00 | 10.00 | 10.00 | 10.00 | 10.00 |
| KEMGARD MZM | 7.50 | 7.50 | 7.50 | 7.50 | 7.50 | 7.50 | 7.50 | 7.50 |
| CAMPINE MT | 2.00 | 2.00 | 2.00 | 2.00 | 2.00 | 2.00 | 2.00 | 2.00 |
| PARALOID K-175 | 0.90 | 0.90 | 0.90 | 0.90 | 0.90 | 0.90 | 0.90 | 0.90 |
| PE AC-629A | 0.15 | 0.15 | 0.15 | 0.15 | 0.15 | 0.15 | 0.15 | 0.15 |
| CALCIUM STEARATE, FN | 0.50 | 0.50 | 0.50 | 0.50 | 0.50 | 0.50 | 0.50 | 0.50 |
| WESTON EHDP | 0.00 | 1.00 | 0.00 | 1.00 | 0.00 | 0.00 | 0.00 | 0.00 |
| LOWINOX CA 22 | | | 0.00 | 0.00 | 0.75 | 0.00 | 0.00 | 0.00 |
| IRGANOX 1076 | | | 0.00 | 0.00 | 0.00 | 0.75 | 0.00 | 0.00 |
| IRGANOX 1010 | | | 0.00 | 0.00 | 0.00 | 0.00 | 0.75 | 0.00 |
| Testing | | | | | | | | |
| Specific Gravity | 1.66 | 1.66 | 1.64 | 1.66 | 1.65 | 1.64 | 1.64 | 1.64 |
| Durometer Hardness, A, Instant | | | 100 | 99.7 | 98.4 | 98 | 98.5 | 96.2 |
| Durometer Hardness, A, 15 sec delay | | | 98.9 | 98.2 | 97.3 | 97.5 | 97.1 | 95.3 |
| Durometer Hardness, D, Instant | 64.2 | 66.4 | 69.4 | 69 | 69.3 | 68.1 | 69 | 66 |
| Durometer Hardness, D, 15 sec delay | 49.6 | 50.7 | 55.6 | 53.1 | 56.7 | 54 | 55.9 | 53.5 |
| Flame: LOI Oxygen Index | 59.1 | 61.1 | | | | | | |
| Flexible Tensile | 2115 | 2167 | 2370 | 2379 | 2405 | 2395 | 2355 | 2246 |
| 100% Modulus | 1727 | 1774 | 1914 | 1902 | 1954 | 1933 | 1841 | 1876 |
| Elongation | 252 | 269 | 252 | 285 | 258 | 268 | 284 | 232 |
| Brittleness of Plastic | >−2 | −6 | | | | | | |
| Dynamic Thermal Stability | 36 | 47 | 27.5 | 31 | 28 | 31 | 34 | 39.5 |
| Flex Tensile - Oven Aged 7 Days 100 C. | 2200 | 2226 | | | | | | |
| 100% Modulus | 1924 | 1800 | | | | | | |
| Elongation | 228 | 290 | | | | | | |
| Retention of Tensile | 104% | 103% | | | | | | |
| Retention of Elongation | 90% | 108% | | | | | | |
| DTS 10 min torque value | 675 | 897 | | | | | | |

TABLE 12

| | Experiments | | | | | | | |
|---|---|---|---|---|---|---|---|---|
| | 8-G | 8-H | 9-A | 9-B | 9-C | 9-D | 9-E | 9-F |
| SUSP RESIN 240F | 100.00 | 100.00 | 100.00 | 100.00 | 100.00 | 100.00 | 100.00 | 100.00 |
| DP-45 | 22.00 | 22.00 | 22.00 | 22.00 | 22.00 | 22.00 | 22.00 | 22.00 |
| CAPA 6500 | 33.00 | 33.00 | 33.00 | 33.00 | 33.00 | 33.00 | 33.00 | 33.00 |
| NAFTOSAFE PKP-717 | 4.50 | 4.50 | 4.50 | 4.50 | 4.50 | 4.50 | 4.50 | 4.00 |
| NAFTOSAFE PKP-1152 | 4.50 | 4.50 | 4.50 | 4.50 | 4.50 | 4.50 | 4.50 | 4.00 |
| CHEMSON EH-554 | | | 0.00 | 0.00 | 0.00 | 0.00 | 0.00 | 2.00 |
| MARK 1900 | 0.30 | 0.45 | | | | | | |
| REAPAK B-NT 7444 | | | 0.00 | 0.00 | 0.00 | 0.00 | 0.50 | 0.00 |
| MARK 2225 | | | 0.00 | 0.50 | 0.00 | 0.00 | 0.00 | 0.00 |
| THERMOLITE 890S (Octyl tin) | | | 0.00 | 0.00 | 0.50 | 0.00 | 0.00 | 0.00 |
| THERMOLITE 813 (Octyl Tin Maleate- | | | 0.00 | 0.00 | 0.00 | 0.50 | 0.00 | 0.00 |
| powder) | | | | | | | | |
| APYRAL 40CD | 43.00 | 43.00 | | | | | | |
| HYMOD 9400 SF | 43.00 | 43.00 | 86.00 | 86.00 | 86.00 | 86.00 | 86.00 | 86.00 |
| CHARMAX LSZST | 10.00 | 10.00 | 10.00 | 10.00 | 10.00 | 10.00 | 10.00 | 10.00 |
| KEMGARD MZM | 7.50 | 7.50 | 7.50 | 7.50 | 7.50 | 7.50 | 7.50 | 7.50 |
| CAMPINE MT | 2.00 | 2.00 | 2.00 | 2.00 | 2.00 | 2.00 | 2.00 | 2.00 |
| PARALOID K-175 | 0.90 | 0.90 | 0.90 | 0.90 | 0.90 | 0.90 | 0.90 | 0.90 |
| PE AC-629A | 0.15 | 0.15 | 0.15 | 0.15 | 0.15 | 0.15 | 0.15 | 0.15 |
| CALCIUM STEARATE, FN | 0.50 | 0.50 | 0.50 | 0.50 | 0.50 | 0.50 | 0.50 | 0.50 |
| WESTON EHDP | 0.00 | 0.00 | 1.00 | 1.00 | 1.00 | 1.00 | 1.00 | 0.00 |
| Testing | | | | | | | | |
| Specific Gravity | 1.64 | 1.64 | 1.68 | 1.68 | 1.66 | 1.67 | 1.66 | 1.67 |
| Durometer Hardness, A, Instant | 98 | 93.8 | | | | | | |
| Durometer Hardness, A, 15 sec delay | 96.6 | 93.1 | | | | | | |
| Durometer Hardness, D, Instant | 65.7 | 67.4 | 69.3 | 68.7 | 70.3 | 69.6 | 69.3 | 70.1 |
| Durometer Hardness, D, 15 sec delay | 53 | 53.4 | 54.5 | 53.3 | 54.8 | 53.3 | 53.7 | 55.3 |
| Flame: LOI Oxygen Index | | | | | | | | |
| Flexible Tensile | 2283 | 2108 | 2267 | 1981 | 2144 | 1965 | 2205 | 2207 |
| 100% Modulus | 1874 | 1714 | 1875 | 1733 | 1850 | 1690 | 1756 | 1739 |
| Elongation | 246 | 252 | 252 | 218 | 223 | 216 | 254 | 258 |
| Brittleness of Plastic | | | −7 | 5.4 | 3.4 | 5.2 | −3.2 | −4.6 |
| Dynamic Thermal Stability | 38 | 37.5 | 33 | 36.5 | 37.6 | 35.5 | 46 | 37 |

TABLE 13

| | Experiments | | | | | | | |
|---|---|---|---|---|---|---|---|---|
| | 9-G | 9-H | 10-A | 10-B | 11-A | 11-B | 11-C | 11-D |
| SUSP RESIN 240F | 100.00 | 100.00 | 100.00 | 100.00 | 100.00 | 100.00 | 100.00 | 0.00 |
| SUSP RESIN OV220F | | | | | 0.00 | 0.00 | 0.00 | 100.00 |
| SYNPLAST NOTM ELECTRICAL | | | 33.00 | | | | | |
| DP-45 | 22.00 | 22.00 | 22.00 | 22.00 | 22.00 | 22.00 | 22.00 | 22.00 |
| CAPA 6500 | 33.00 | 33.00 | | 33.00 | 33.00 | 33.00 | 33.00 | 33.00 |
| NAFTOSAFE PKP-717 | 4.50 | 4.50 | 8.00 | 4.50 | 4.50 | 4.50 | 4.50 | 4.50 |
| NAFTOSAFE PKP-1152 | 4.50 | 4.50 | | 4.50 | 4.50 | 4.50 | 4.50 | 4.50 |
| MARK 1900 | | | | 0.20 | 0.00 | 0.00 | 0.20 | 0.00 |
| APYRAL 40CD | | | 43.00 | 43.00 | 43.00 | 43.00 | 43.00 | 43.00 |
| HYMOD 9400 SF | 86.00 | 86.00 | 43.00 | 43.00 | 43.00 | 43.00 | 43.00 | 43.00 |
| CHARMAX LSZST | 10.00 | 10.00 | 10.00 | 10.00 | 10.00 | 10.00 | 10.00 | 10.00 |
| KEMGARD MZM | 7.50 | 7.50 | 7.50 | 7.50 | 7.50 | 7.50 | 7.50 | 7.50 |
| CAMPINE MT | 2.00 | 2.00 | 2.00 | 2.00 | 2.00 | 2.00 | 2.00 | 2.00 |
| PARALOID K-175 | 0.90 | 0.90 | 1.20 | 0.90 | 0.90 | 0.90 | 0.90 | 0.90 |
| PE AC-629A | 0.15 | 0.15 | 0.20 | 0.15 | 0.15 | 0.15 | 0.15 | 0.15 |
| CALCIUM STEARATE, FN | 0.50 | 0.50 | | 0.50 | 0.50 | 0.50 | 0.50 | 0.50 |
| WESTON EHDP | 0.00 | 0.00 | | 1.00 | | | | |
| WESTON 618F | 1.00 | 0.00 | | | 0.00 | 1.00 | 1.00 | 1.00 |
| ULTRANOX 626 | 0.00 | 1.00 | | | | | | |
| Testing | | | | | | | | |
| Specific Gravity | 1.66 | 1.65 | 1.67 | 1.67 | 1.65 | 1.65 | 1.65 | 1.65 |
| Durometer Hardness, A, Instant | | | 99.1 | 99.7 | | | | |
| Durometer Hardness, A, 15 sec delay | | | 98.2 | 96.1 | | | | |
| Durometer Hardness, D, Instant | 70.3 | 70.3 | 64.9 | 60 | 69.9 | 68.4 | 66.4 | 68.2 |
| Durometer Hardness, D, 15 sec delay | 55.4 | 55.1 | 55.3 | 47.3 | 55.1 | 53.2 | 52.4 | 53.1 |
| Flame: LOI Oxygen Index | | | 62.8 | 61 | 61.2 | 62.3 | 61.8 | 60.3 |
| Flexible Tensile | 2104 | 2166 | 1902 | 1785 | 2294 | 2153 | 2254 | 2008 |
| 100% Modulus | 1726 | 1732 | 1688 | 1522 | 1838 | 1684 | 1906 | 1583 |
| Elongation | 239 | 261 | 205 | 227 | 250 | 264 | 219 | 298 |
| Cone Calorimeter PHR | | | 113.5 | 84 | 79 | 79.5 | 75.3 | |
| Cone Calorimeter THR | | | 55.5 | 53.5 | 44.3 | 52.9 | 53.8 | |
| Cone Calorimeter AvgSEA | | | 253 | 119 | 137 | 156 | 82 | |
| Cone Calorimeter TOTSMK | | | 1710 | 819 | 1471 | 1074 | 718 | |
| Brittleness of Plastic | −7.8 | −6.4 | −4.2 | −1.4 | −7.4 | −9.2 | 0.8 | −8.4 |
| Dynamic Thermal Stability | 45 | 38 | 72 | 46 | 27 | 35.5 | 47 | 47 |
| Flex Tensile - Oven Aged 7 Days 121 C. | | | | | 2314 | 2163 | 2330 | 2024 |
| 100% Modulus | | | | | 1872 | 1888 | 2007 | 1768 |
| Elongation | | | | | 276 | 236 | 192 | 270 |
| Retention of Tensile | | | | | 101% | 100% | 103% | 101% |
| Retention of Elongation | | | | | 110% | 89% | 88% | 91% |
| Flex Tensile - Oven Aged 10 Days 100 C. | | | 1959 | 1783 | | | | |
| 100% Modulus | | | 1819 | 1601 | | | | |
| Elongation | | | 133 | 207 | | | | |
| Retention of Tensile | | | 103% | 100% | | | | |
| Retention of Elongation | | | 65% | 91% | | | | |
| DTS Torque @ 15 min. | | | 520 | 872 | | | | |
| Temperature @ 15 min. | | | 210 | 205 | | | | |
| Torque at 5 minutes | | | | | 1022 | 1017 | 913 | 885 |

TABLE 14

| | Experiments | | | |
|---|---|---|---|---|
| | 11-E | 12-A | 12-B | 12-C |
| SUSP RESIN OV220F | 100.00 | 100.00 | 100.00 | 100.00 |
| DP-45 | 22.00 | 22.00 | 22.00 | 22.00 |
| CAPA 6500 | 33.00 | 33.00 | 33.00 | 33.00 |
| NAFTOSAFE PKP-717 | 4.50 | 4.50 | 4.50 | 4.50 |
| NAFTOSAFE PKP-1152 | 4.50 | 4.50 | 4.50 | 4.50 |
| MARK 1900 | 0.20 | | | |
| APYRAL 40CD | 43.00 | 43.00 | 43.00 | 43.00 |
| HYMOD 9400 SF | 43.00 | 43.00 | 43.00 | 43.00 |
| CHARMAX LSZST | 10.00 | 10.00 | 10.00 | 10.00 |
| KEMGARD MZM | 7.50 | 7.50 | 7.50 | 7.50 |
| CAMPINE MT | 2.00 | 2.00 | 2.00 | 2.00 |
| PARALOID K-175 | 0.90 | 0.90 | 0.90 | 0.90 |
| PE AC-629A | 0.15 | 0.15 | 0.15 | 0.15 |
| CALCIUM STEARATE, FN | 0.50 | 0.50 | 0.50 | 0.50 |
| WESTON 618F | 1.00 | 1.00 | 1.00 | 1.00 |
| Testing | | | | |
| Specific Gravity | 1.65 | 1.66 | 1.66 | 1.66 |
| Durometer Hardness, A, Instant | | 98.3 | 98.8 | 97.8 |
| Durometer Hardness, A, 15 sec | | 96.5 | 97.6 | 95.4 |
| delay | | | | |
| Durometer Hardness, D, Instant | 66.6 | 68.1 | 69.2 | 66.1 |
| Durometer Hardness, D, 15 sec | 52.5 | 54.2 | 56.2 | 50.3 |
| delay | | | | |
| Flame: LOI Oxygen Index | 59.1 | 63.4 | 62.4 | 61.8 |
| Flexible Tensile | 1919 | 2068 | 2149 | 1978 |
| 100% Modulus | 1634 | 1607 | 1740 | 1582 |
| Elongation | 252 | 298 | 290 | 283 |
| Cone Calorimeter PHR | | | | 89.5 |
| Cone Calorimeter THR | | | | 80.2 |
| Cone Calorimeter AvgSEA | | | | 175 |
| Cone Calorimeter TOTSMK | | | | 1334 |
| Brittleness of Plastic | 0.4 | −6.4 | −3.6 | −7.6 |
| Dynamic Thermal Stability | 58 | 34 | 33.5 | 39.5 |
| Flex Tensile - Oven Aged 7 Days | 2196 | 2321 | 2187 | 1925 |
| 121 C. | | | | |
| 100% Modulus | 2050 | 2095 | 2017 | 1759 |
| Elongation | 196 | 213 | 178 | 225 |
| Retention of Tensile | 114% | 112% | 102% | 97% |
| Retention of Elongation | 78% | 71% | 61% | 80% |
| Torque at 5 minutes | 690 | 894 | 920 | 872 |

As result of the 12 Series of experiments, it can be summarized that Experiments 3-A; 3-B; 4-B; 4-C; 4-D; 4-E; 4-F; 7-A; 7-G; 9-A; 9-E; 9-F; 9-G; 9-H; 10-B; 11-A; 11-B; 11-D; 12-A; 12-B; and 12-C are Examples of the present invention with the remainder of Experiments serving as Comparative Examples.

It has also been found via photo-micrographic evaluation that the polycaprolactone and the PVC are no less than compatible into a single phase morphology and probably are miscible together. This compatibility or miscibility aids in retention of the polymeric plasticizer to minimize undesired migration of the polycaprolactone from within the PVC or from the PVC to its surfaces or to a contiguous second material.

The invention is not limited to the above embodiments. The claims follow.

What is claimed is:

1. A wire or cable covering, comprising:
a mixture of
(a) poly(vinyl chloride) and
(b) polycaprolactone plasticizing the poly(vinyl chloride),
wherein the mixture has a Limiting Oxygen Index of greater 60% according to ASTM D2863; an Elongation at Break of greater than 150% according to ASTM D638 (Type IV); a Plastic Brittleness less than 0° C. according to ASTM D746 as measured in 2° C. increments; and a Dynamic Thermal Stability of more than 25 min according to ASTM 2538.

2. The wire or cable covering of claim 1, wherein the mixture also comprises brominated phthalate plasticizer.

3. The wire or cable covering of claim 2, wherein the mixture has a parts per hundred of poly(vinyl chloride) resin ratio of from about 1:2 to about 1:1 of the brominated phthalate plasticizer:polycaprolactone.

4. The wire or cable covering of claim 3, wherein the mixture has a parts per hundred of poly(vinyl chloride) resin ratio of about 1:2 to about 3:4 of the brominated phthalate plasticizer:polycaprolactone.

5. The wire or cable covering of claim 1, wherein the mixture also comprises distearyl pentaerythritol diphosphite stabilizer.

6. The wire or cable covering of claim 5, wherein the distearyl pentaerythritol diphosphite stabilizer is present in the mixture in an amount of about 0.2 to about 2 parts per hundred of poly(vinyl chloride) resin.

7. The wire or cable covering of claim 1, wherein the mixture excludes dimethyl tin mercaptan.

8. The wire or cable covering of claim 1, wherein the wire or cable is a plenum wire or cable.

9. The wire or cable covering of claim 1, wherein the wire or cable is a riser wire or cable.

10. A wire or cable, comprising a transmission core of optical fiber or metal wire and a covering of claim 1.

11. The wire or cable of claim 10, wherein the wire or cable is a plenum wire or cable.

12. The wire or cable of claim 10, wherein the wire or cable is a riser wire or cable.

13. A method of using plasticized poly(vinyl chloride) in wire or cable covering, comprising the steps:
(a) mixing polycaprolactone with polyvinyl chloride to form a plasticized polyvinyl chloride;
(b) extruding the plasticized polyvinyl chloride around a transmission core of optical fiber or metal wire to form a plenum wire or cable which passes the UL-910 test.

14. A plenum wire or cable, comprising: polyvinyl chloride plasticized with polycaprolactone as a covering according to the mixture of claim 1 wherein the plenum wire or cable passes the UL-910 test.

15. An industrial curtain, comprising the mixture of claim 1.
